(19) United States
(12) Patent Application Publication
(10) Pub. No.: US 2024/0273466 A1
(43) Pub. Date: Aug. 15, 2024

(54) INFORMATION PROCESSING DEVICE, INFORMATION PROCESSING SYSTEM, AND NON-TRANSITORY COMPUTER-READABLE MEDIUM

(71) Applicant: TESNOLOGY INC., Tokyo (JP)

(72) Inventors: Katsuhiko Kondo, Tokyo (JP); Akihiko Matsumura, Tokyo (JP)

(21) Appl. No.: 18/641,015

(22) Filed: Apr. 19, 2024

Related U.S. Application Data
(63) Continuation of application No. PCT/JP2022/038034, filed on Oct. 12, 2022.

(30) Foreign Application Priority Data
Oct. 22, 2021 (JP) 2021-173094

(51) Int. Cl. G06Q 10/087; G06Q 50/04

(52) U.S. Cl. CPC G06Q 10/087; G06Q 50/04

(57) ABSTRACT

An information processing device is provided. The device acquires, from a recording medium added to a product, a first address indicating a first storage location on a network related to production record data of the product. The device accesses the first address to receive the production record data of the product. The device obtains, from the received production record data of the product, a second address indicating a second storage location on the network related to production record data of a raw material or a component. The device accesses the second address to receive the production record data of the raw material or the component. The device outputs a part or all of the production record data of the product and the production record data of the raw material or the component.

### CROSS-REFERENCE TO RELATED APPLICATION(S)

This application is a Continuation of International Patent Application No. PCT/JP2022/038034, filed on Oct. 12, 2022, which claims the benefit of Japanese Patent Application No. 2021-173094, filed on Oct. 22, 2021, both of which are hereby incorporated by reference herein in their entirety.

### BACKGROUND OF THE INVENTION

### Field of the Invention

The present invention relates to a product tracing technique.

### Description of the Related Art

In recent years, problems such as false designation of origin of foodstuffs, tampering with expiration dates, distribution of imitation or counterfeit goods, and the like occur occasionally. In view of this point, a mechanism is widely used in which a supplier of a target product or a food product provides trace information and a consumer can freely consult this information using a smartphone or the like at the time of purchase.

Japanese Patent No. 5194285 discloses a technique in which a producer divides goods based on weight, hands trace tags (two dimensional code labels) prepared as many as the number of divided goods together with the divided goods to a wholesaler being a successful bidder, records the number thereof and identification information of the wholesaler as individual information in a database on a manager side in association with each other, and a retailer also obtains the trace tags as many as the number of divided goods that have been handed over and attaches them to the divided goods.

### SUMMARY OF THE INVENTION

According to an embodiment of the present invention, an information processing device comprises one or more memories storing instructions and one or more processors that execute the instructions to: acquire, from a recording medium added to a product, a first address indicating a first storage location on a network related to production record data of the product; access the first address to receive the production record data of the product; obtain, from the received production record data of the product, a second address indicating a second storage location on the network related to production record data of a raw material or a component; access the second address to receive the production record data of the raw material or the component; and output a part or all of the production record data of the product and the production record data of the raw material or the component.

According to another embodiment of the present invention, an information processing system comprises one or more memories storing instructions and one or more processors that execute the instructions to: acquire, from a first recording medium added to a raw material or a component of a product, a first address indicating a first storage location on a network related to production record data of the raw material or the component; generate production record data of the product, the production record data including an item for the product and an item for the raw material or the component and associating the acquired first address with the item for the raw material or the component; and record, on a second recording medium to be added to the product, a second address indicating a second storage location on the network related to the production record data of the product.

According to still another embodiment of the present invention, an information processing system comprises one or more memories storing instructions and one or more processors that execute the instructions to: acquire, from a first recording medium added to a raw material or a component, a first address in an arrival stage of the raw material or the component, the first address indicating a first storage location on a network for storing production record data of the raw material or the component; register, in arrival management data, the acquired first address and an arrival date of the raw material or the component in association with each other; generate production record data of a product in a production stage of the product using one or more of the raw materials or the components; detect the arrival date of the one or more of the raw materials or the components by searching the arrival management data based on the first address corresponding to the one or more of the raw materials or the components; set the arrival date of the one or more of the raw materials or the components in the production record data of the product; and record, on a second recording medium to be added to the product, a second address indicating a second storage location on the network related to the production record data of the product.

According to yet another embodiment of the present invention, a non-transitory computer-readable medium stores a program executable by an information processing device to perform a method comprising: acquiring, from a recording medium added to a product, a first address indicating a first storage location on a network related to production record data of the product; accessing the first address and receiving the production record data of the product; obtaining, from the received production record data of the product, a second address indicating a second storage location on the network related to production record data of a raw material or a component; accessing the second address and receiving the production record data of the raw material or the component; and outputting a part or all of the production record data of the product and the production record data of the raw material or the component.

According to still yet another embodiment of the present invention, a non-transitory computer-readable medium stores a program executable by an information processing system to perform a method comprising: acquiring, from a first recording medium added to a raw material or a component of a product, a first address indicating a first storage location on a network related to production record data of the raw material or the component; generating production record data of the product, the production record data including an item for the product and an item for the raw material or the component and associating the acquired first address with the item for the raw material or the component; and recording, on a second recording medium to be added to the product, a second address indicating a second storage location on the network related to the production record data of the product.

According to yet still another embodiment of the present invention, a non-transitory computer-readable medium stores a program executable by an information processing system to perform a method comprising: acquiring, from a first recording medium added to a raw material or a component in an arrival stage of the raw material or the component, a first address indicating a first storage location on a network for storing production record data of the raw material or the component; registering, in arrival management data, the acquired first address and an arrival date of the raw material or the component in association with each other; generating production record data of a product in a production stage of the product using one or more of the raw materials or the components; detecting the arrival date of the one or more of the raw materials or the components by searching the arrival management data based on the first address corresponding to the one or more of the raw materials or the components; setting the arrival date of the one or more of the raw materials or the components in the production record data of the product; and recording, on a second recording medium to be added to the product, a second address indicating a second storage location on the network related to the production record data of the product.

Further features of the present invention will become apparent from the following description of exemplary embodiments (with reference to the attached drawings).

### BRIEF DESCRIPTION OF THE DRAWINGS

FIG. 1 is a diagram illustrating an example of a flow of a product and a raw material.

FIG. 2 is a diagram illustrating an example of production record data of red bean soup.

FIG. 3 is a diagram illustrating an example of production record data of mashed red bean paste.

FIG. 4 is a diagram illustrating an example of production record data of a round rice cake.

FIG. 5 is a diagram illustrating an example of production record data of red beans.

FIG. 6 is a diagram illustrating an example of production record data of sugar.

FIG. 7 is a diagram illustrating an example of production record data of glutinous rice.

FIG. 8 is a diagram illustrating an example of production record data of sugar cane.

FIG. 9 is a diagram illustrating an example of a trace information screen.

FIG. 10 is a functional block diagram of a user terminal.

FIG. 11 is a flowchart illustrating a process of trace information display in a user terminal.

FIG. 12 is a diagram illustrating an outline of the work in a food product factory and an operation of the trace information management system.

FIG. 13 is a functional block diagram of a trace information management terminal.

FIG. 14 is a diagram illustrating a first example of a method of collecting a production record data uniform resource locator (URL).

FIG. 15 is a diagram illustrating a second example of the method of collecting the production record data URL.

FIG. 16 is a diagram illustrating a third example of the method of collecting the production record data URL.

FIG. 17 is a diagram illustrating an example of arrival management data.

FIG. 18 is a flowchart illustrating a process of performing an arrival processing of a raw material or a component in the trace information management terminal.

FIG. 19 is a diagram illustrating an example of a production record data editing screen of the red bean soup.

FIG. 20 is a diagram illustrating an example of a template of the production record data of the red bean soup.

FIG. 21 is a flowchart illustrating a process of issuing a production record data in the trace information management terminal.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In the technique disclosed in Japanese Patent No. 5194285, when the central server writes information, whether the information is genuine or counterfeit/false is determined based on the digital signature, but if the digital signature is tampered with, counterfeit/false information is registered.

In relation to this, Japanese Patent No. 6811220 discloses a technique for securing the validity of registered information using a blockchain. However, in a system using the blockchain, a large amount of power is consumed for mining processing, and there is a concern that global warming such as an increase in emission amount of carbon dioxide is accelerated.

In both Japanese Patent No. 5194285 and Japanese Patent No. 6811220, the range of tracing is limited, and it is not suitable for a wide range and variety of tracing such as a final product, an intermediate product, and a raw material.

An embodiment of the present invention provides a technique in which the production record data of a raw material or a component can be traced, the raw material and the component being upstream from a product being a starting point.

### EMBODIMENT

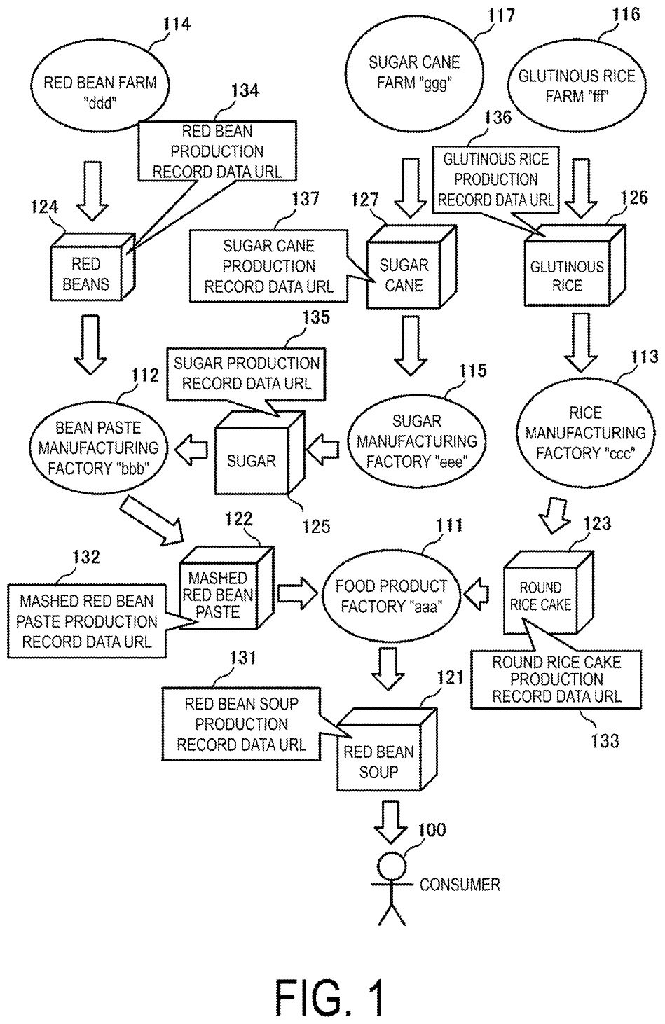

FIG. 1 illustrates an example of a flow of a product and a raw material.

A processed food, which is an example of a product, is manufactured by processing various foodstuffs (such as crops/meat/fish). In addition, final food may be completed by processing by a plurality of business operators. Here, an example in which “red bean soup” is produced as a final product is illustrated.

The “red bean soup” is typical Japanese food, and is prepared by dissolving “mashed red bean paste” with water and adding a “round rice cake” thereto. The “mashed red bean paste” is obtained by adding “sugar” to a paste obtained by boiling and lightly mashing “red beans”. “Sugar” is made, for example, from “sugar cane”. The “round rice cake” is obtained by shaping a rice cake made with steamed “glutinous rice” into a circular shape.

In this example, a red bean farm 114, which is a business operator named “ddd”, produces red beans 124 and sells the red beans 124 in containers. A sugar cane farm 117, which is a business operator named “ggg”, produces sugar cane 127 and sells the sugar cane 127 in containers. A glutinous rice farm 116, which is a business operator named “fff”, produces glutinous rice 126 and sells the glutinous rice 126 in containers.

A sugar manufacturing factory 115, which is a business operator named “eee”, purchases the sugar cane 127 as a raw material, produces sugar 125, and sells the sugar 125 in containers. A bean paste manufacturing factory 112, which is a business operator named “bbb”, purchases the red beans 124 and the sugar 125 as raw materials, produces mashed red bean paste 122, and sells the mashed red bean paste 122 in containers. A rice cake manufacturing factory 113, which is a business operator named “ccc”, purchases glutinous rice 126 as a raw material, produces round rice cake 123, and sells the round rice cake 123 in containers.

A food product factory 111, which is a business operator named “aaa”, purchases the mashed red bean paste 122 and the round rice cake 123, which are raw materials, produces the red bean soup 121, and sells the red bean soup 121 in containers. Then, the consumer 100 purchases the red bean soup 121. In this example, the sugar 125, the mashed red bean paste 122, and the round rice cake 123 are intermediate products for producing the final product, the red bean soup 121, but the sugar 125, the mashed red bean paste 122, and the round rice cake 123 themselves may be purchased by the consumer 100 as the final product.

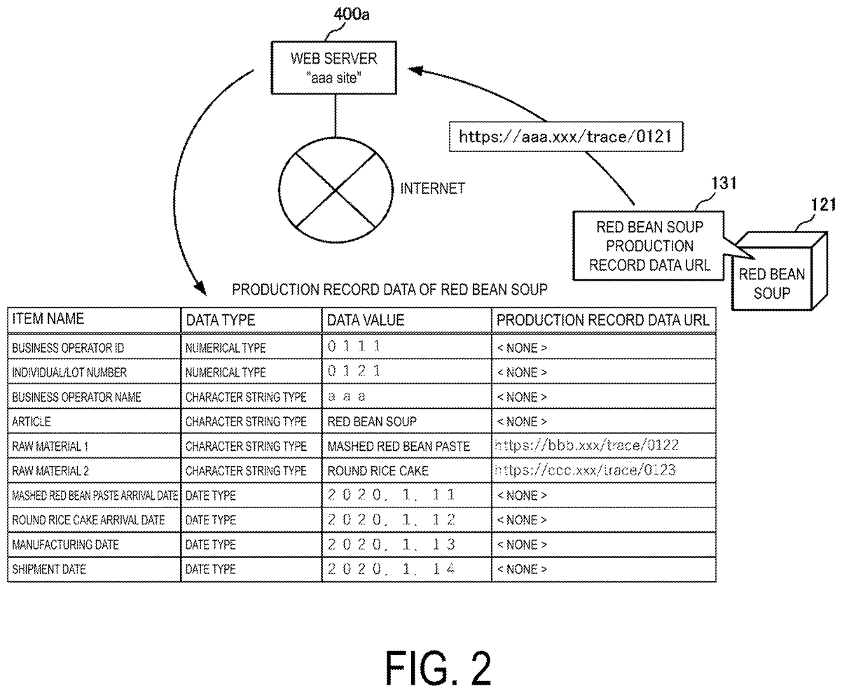

Each business operator generates production record data related to a product produced by the business operator. The production record data is data including a record related to production of a product. The production record data will be described later with reference to FIGS. 2 to 8. In addition, a recording medium (e.g., a bar code, a QR code (registered trade name), an RFID tag, or the like) is added or attached to each good, and a URL indicating a storage location of the production record data on the network is recorded on the recording medium. Specifically, the red bean soup production record data URL 131 is recorded on the recording medium of the red bean soup 121, the mashed red bean paste production record data URL 132 is recorded on the recording medium of the mashed red bean paste 122, the round rice cake production record data URL 133 is recorded on the recording medium of the round rice cake 123, and the sugar production record data URL 135 is recorded on the recording medium of the sugar 125. In addition, the red bean production record data URL 134 is recorded on the recording medium of the red beans 124, the glutinous rice production record data URL 136 is recorded on the recording medium of the glutinous rice 126, and the sugar cane production record data URL 137 is recorded on the recording medium of the sugar cane 127.

FIG. 2 is a diagram illustrating an example of production record data of the red bean soup 121.

The production record data in this example is in a table format. In the production record data, a record is provided for each item of the production record. The production record data has the columns item name, data type, data value, and production record data URL. The data type indicates a type of a data value of the item.

The first item is a business operator ID. The business operator ID is uniquely assigned to a business operator and is used to identify the business operator. The second item is an individual/lot number. Either an individual number or a lot number is used. The individual number specifies a good for each good to be traded. The individual number is, for example, a serial number. The lot number identifies the lot in the manufacturing process.

The third item is a business operator name. The fourth item is an article. An article refers to a type of good (e.g., a crop or product).

When raw materials or components are used for crops, products, or the like, items related to the raw materials or components are also provided. In this example, the items for raw material 1 and raw material 2 are provided. Raw material 1 is mashed red bean paste 122, and raw material 2 is the round rice cake 123. Furthermore, a production record data URL is set for the item for the raw material or the component. The production record data URL indicates a storage location on the network where production record data of a raw material or a component is stored. Therefore, by accessing the production record data URL, the production record data of the raw material or the component can be obtained. The example in which the URL is used as one example of the address (identifier of the data storage location on the network) for specifying the data storage location on the network has been described. The address for specifying the data storage location on the network is not limited to the URL, and may be a combination of the IP address of the server in which the data is stored and the folder.

This is followed by a date item indicating the process of production. Specifically, items for an arrival date of the raw material or component, a manufacturing date of the product, and a shipment date of shipping the product as a good are provided. In this example, items for mashed red bean paste arrival date, round rice cake arrival date, manufacturing date (of red bean soup 121), and shipment date (of red bean soup 121) are provided, and each date is set as a data value.

The production record data of the red bean soup 121 is uploaded to the WEB server 400a and can be referred to by an entity other than the food product factory 111 being a production business operator via a network. Uploading means transmitting data to a computer (e.g., WEB server) on a network. That is, the information processing device connected to the network can acquire the production record data of the red bean soup 121 by accessing the red bean soup production record data URL 131 (“https://aaa.xxx/trace/0121”) read from the recording medium added or attached to the container of the red bean soup 121. The means for acquiring the production record data by the URL is the same in the case of other products and crops.

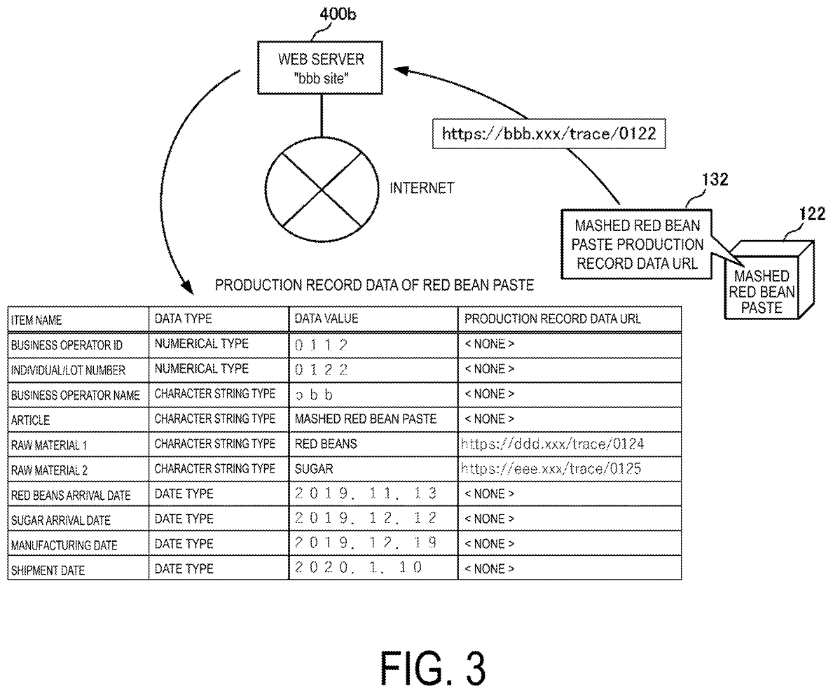

FIG. 3 is a diagram illustrating an example of a production record data of the mashed red bean paste 122.

The production record data of the mashed red bean paste 122 has a similar configuration adapted to the circumstances of the mashed red bean paste 122 according to the gist described in FIG. 2.

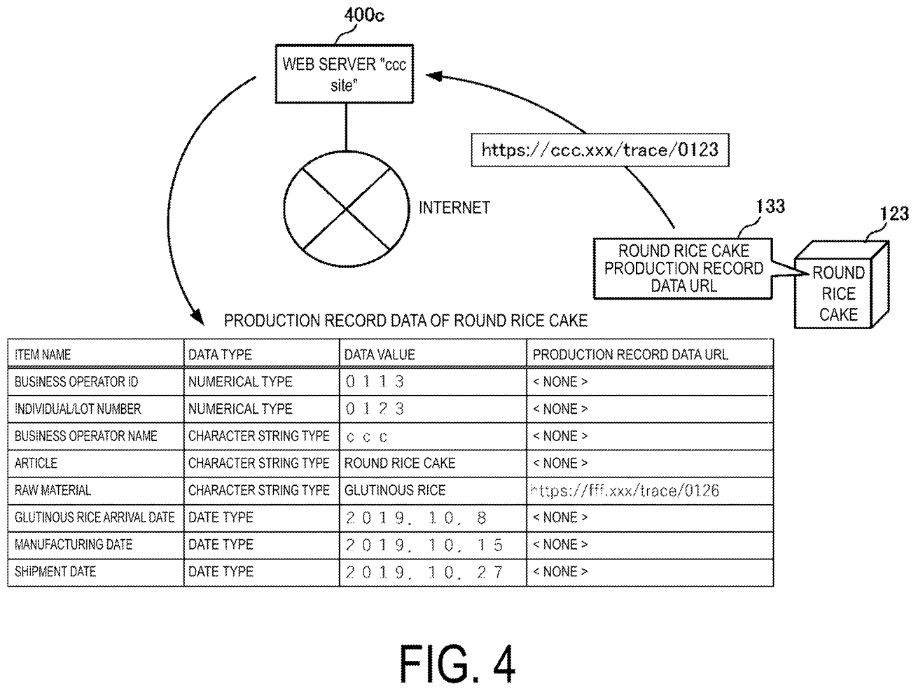

FIG. 4 is a diagram illustrating an example of production record data of the round rice cake 123.

The production record data of the round rice cake 123 has a similar configuration adapted to the circumstances of the round rice cake 123 according to the gist described in FIG. 2.

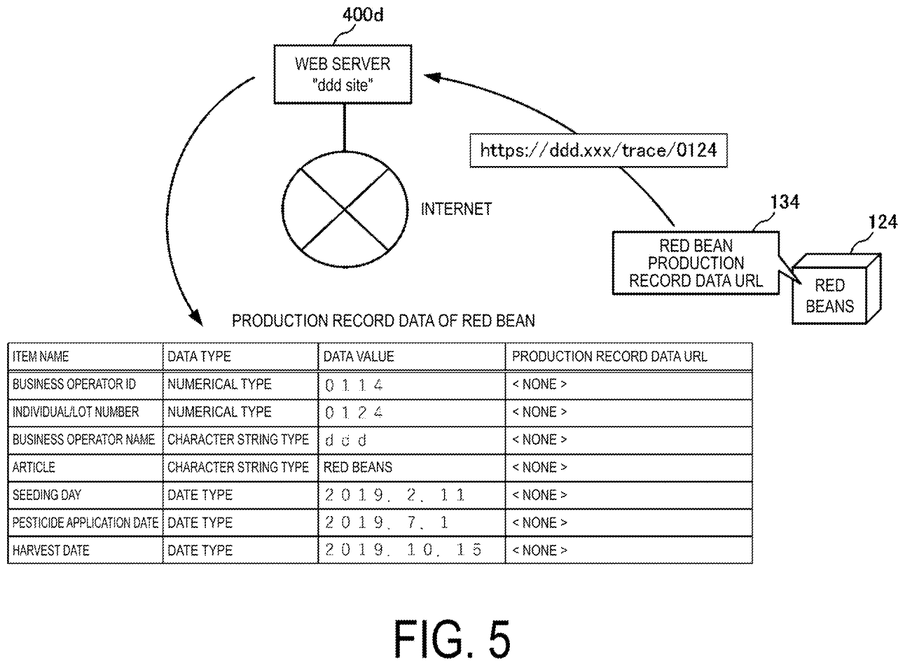

FIG. 5 is a diagram illustrating an example of production record data of the red beans 124.

The first to fourth items in the production record data of the red beans 124 are the same as those in FIG. 2. In this example, the red beans 124, which is a crop, has no item for raw material or component. Items such as used fertilizers and pesticides may be provided as raw materials. As date items, a seeding date, a pesticide application date, and a harvest date are provided.

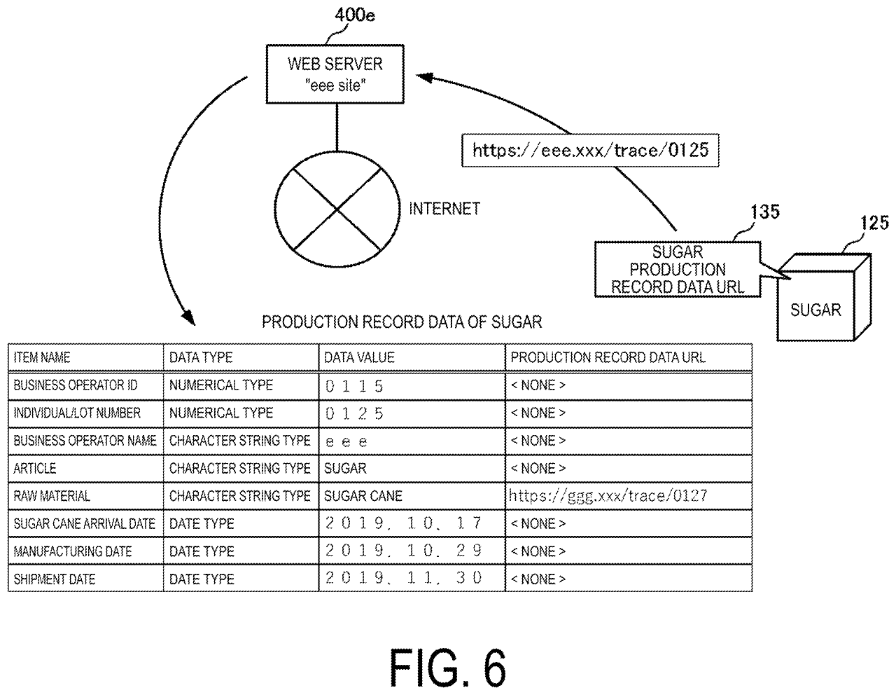

FIG. 6 is a diagram illustrating an example of production record data of the sugar 125.

The production record data of the sugar 125 has a similar configuration adapted to the circumstances of the sugar 125 according to the gist described in FIG. 2.

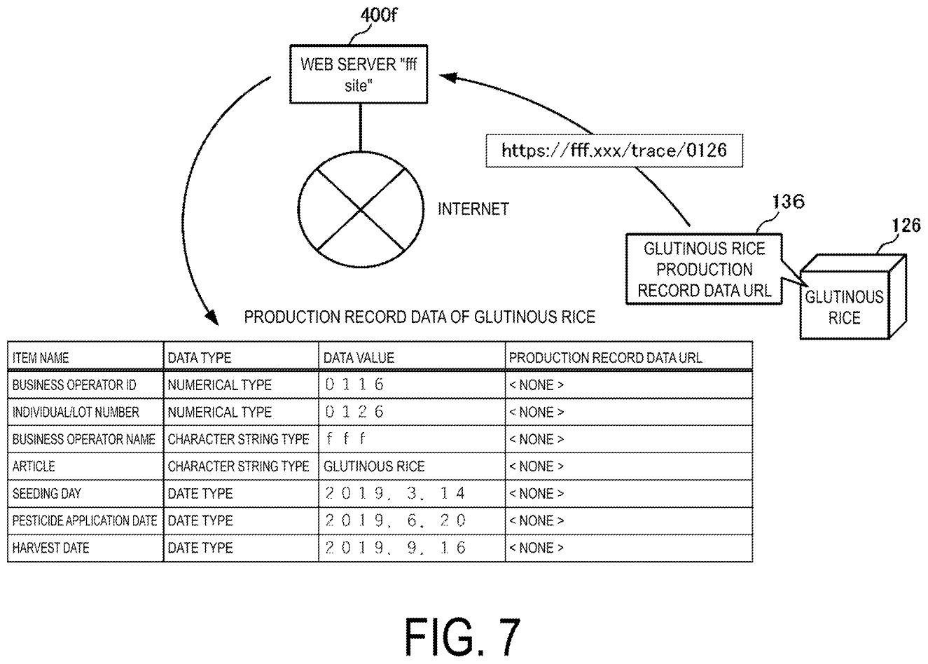

FIG. 7 is a diagram illustrating an example of production record data of the glutinous rice 126.

The production record data of the glutinous rice 126 has a similar configuration adapted to the circumstances of the glutinous rice 126 according to the gist described in FIGS. 2 and 5.

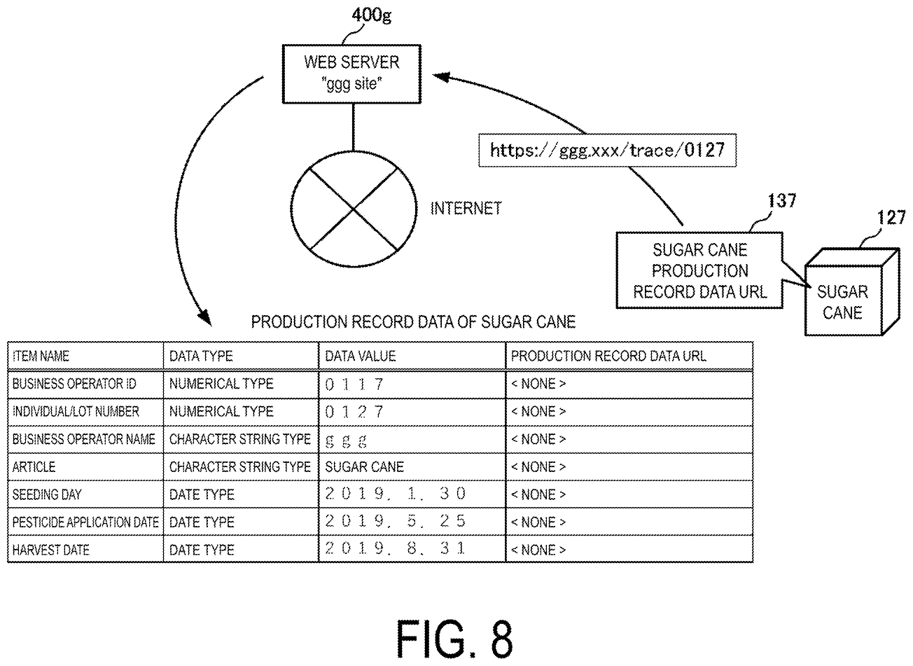

FIG. 8 is a diagram illustrating an example of production record data of the sugar cane 127.

The production record data of the sugar cane 127 has a similar configuration adapted to the circumstances of the sugar cane 127 according to the gist described in FIGS. 2 and 5.

Items other than the above described items may be provided in the production record data. The date item may be a date other than the above. Each production record data URL is different for each combination of a business company being a producer and an individual (or a lot). That is, the combination of the business operator ID and the individual/lot number corresponds to the production record data URL on a one to-one basis. The production record data URL may include a parameter indicating a business operator ID or an individual/lot number.

If the storage position on the network can be specified by the production record data URL, the storage position may be freely selected. In the above-described example, the production record data related to each product is stored in the WEB server 400 different for each business operator, but the production record data related to each product may be stored in the same WEB server 400 in a plurality of business operators.

In this way, the production record data of the product is linked with the production record data of the raw material or component. Thus, it is possible to trace from the product to the original raw material or component in multiple steps, including intermediate products. The production record data of each product that can be collected in the process of tracing can be collectively regarded as trace information.

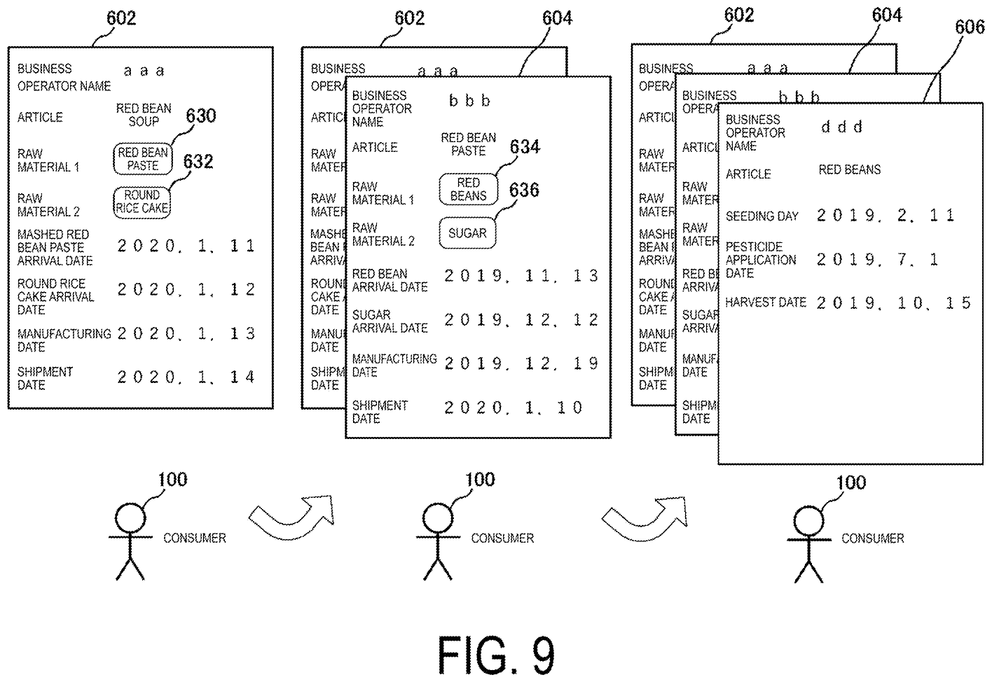

FIG. 9 is a diagram illustrating an example of a trace information screen.

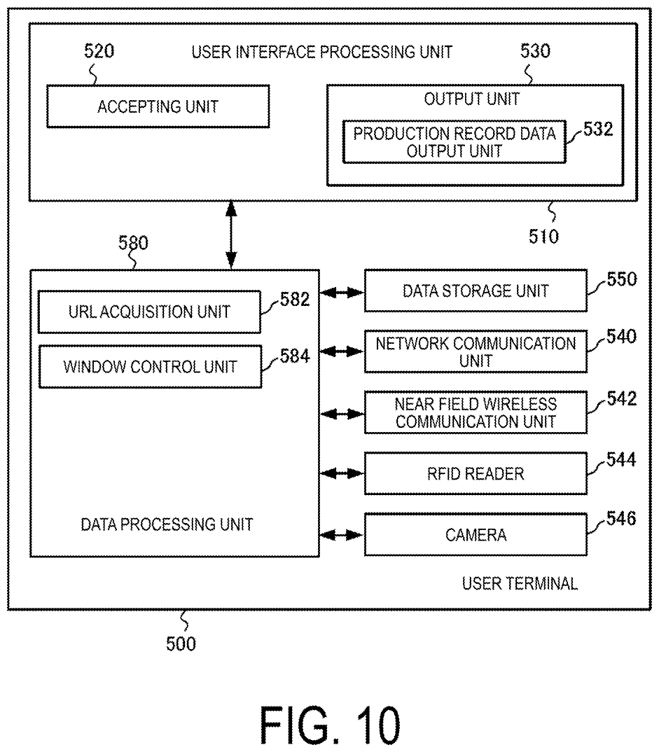

The trace information screen is displayed on the user terminal 500 (see FIG. 10) held by the consumer 100. In this example, the consumer 100 can display the trace information screen on the user terminal 500 by reading the red bean soup production record data URL 131 from the recording medium added or attached to the container of the red bean soup 121 using the user terminal 500. The user terminal 500 is, for example, a smartphone, a tablet terminal, a personal computer, or the like.

First, a red bean soup production record data window 602 is displayed. The contents of each item included in the production record data of the red bean soup 121 are displayed in the red bean soup production record data window 602. In this example, the business operator ID and the individual/lot number are omitted, but the business operator ID and the individual/lot number may be displayed. With respect to the raw material or the component among the displayed items, a reference button for instructing display of production record data of the raw material or the component is displayed. In this example, a mashed red bean paste button 630 and a round rice cake button 632 are displayed.

When the mashed red bean paste button 630 is touched, the mashed red bean paste production record data window 604 is displayed on top and becomes active. The mashed red bean paste production record data window 604 displays the content of each item included in the production record data of the mashed red bean paste 122. A red bean button 634 and a sugar button 636 are displayed as reference buttons.

When the red bean button 634 is touched, a red bean production record data window 606 is displayed on top and becomes active. In the red bean production record data window 606, the contents of each item included in the production record data of the red beans 124 are displayed.

When the red bean production record data window 606 is closed, the mashed red bean paste production record data window 604 thereunder becomes active. In the mashed red bean paste production record data window 604, when the sugar button 636 is touched, a sugar production record data window (not illustrated) is displayed on top.

When the mashed red bean paste production record data window 604 is closed, the red bean soup production record data window 602 thereunder becomes active. When the round rice cake button 632 is touched in the red bean soup production record data window 602, a round rice cake production record data window (not illustrated) is displayed on top and becomes active.

As described above, regarding the product, the raw material, and the component, the production record data window can be freely switched and displayed in the upstream and downstream directions.

FIG. 10 is a functional block diagram of the user terminal 500. Each constituent element of the user terminal 500 is realized by hardware including an arithmetic unit such as a central processing unit (CPU) and various coprocessors, a storage device such as a memory and a storage, and a wired or wireless communication line connecting the arithmetic unit and the storage device, and software that is stored in the storage device and supplies a processing command to the arithmetic unit. The computer program may be configured by a device driver, an operating system, various application programs located in higher layers thereof, and a library that provides common functions to these programs. Each illustrated block mainly represents a block of a functional unit. Each block may be realized by causing an arithmetic unit to execute a program stored in a storage device. The same applies to a trace information management terminal 200 to be described later.

The user terminal 500 includes a user interface processing unit 510, a data processing unit 580, a network communication unit 540, a near field wireless communication unit 542, and a data storage unit 550. The user interface processing unit 510 accepts an operation from a user via a mouse, a touch panel, or the like, and is also responsible for user interface processing such as image display and audio output. The network communication unit 540 is responsible for communication processing via a network. The near field wireless communication unit 542 is responsible for communication processing by near field wireless communication. The data storage unit 550 stores various data. The data processing unit 580 executes various processes based on the data acquired by the network communication unit 540 and the near field wireless communication unit 542 and the data stored in the data storage unit 550. The data processing unit 580 also functions as an interface of the user interface processing unit 510, the network communication unit 540, the near field wireless communication unit 542, and the data storage unit 550. In addition, the user terminal 500 incorporates an RFID reader 544 and a camera 546. The RFID reader 544 and the camera 546 may be externally attached.

The user interface processing unit 510 includes an accepting unit 520 to which data is input by a user operation and an output unit 530 that outputs data to be provided to the user. The output unit 530 includes a production record data output unit that outputs production record data.

The data processing unit 580 includes a URL acquisition unit 582 that acquires a production record data URL and a window control unit 584 that controls a window to be displayed.

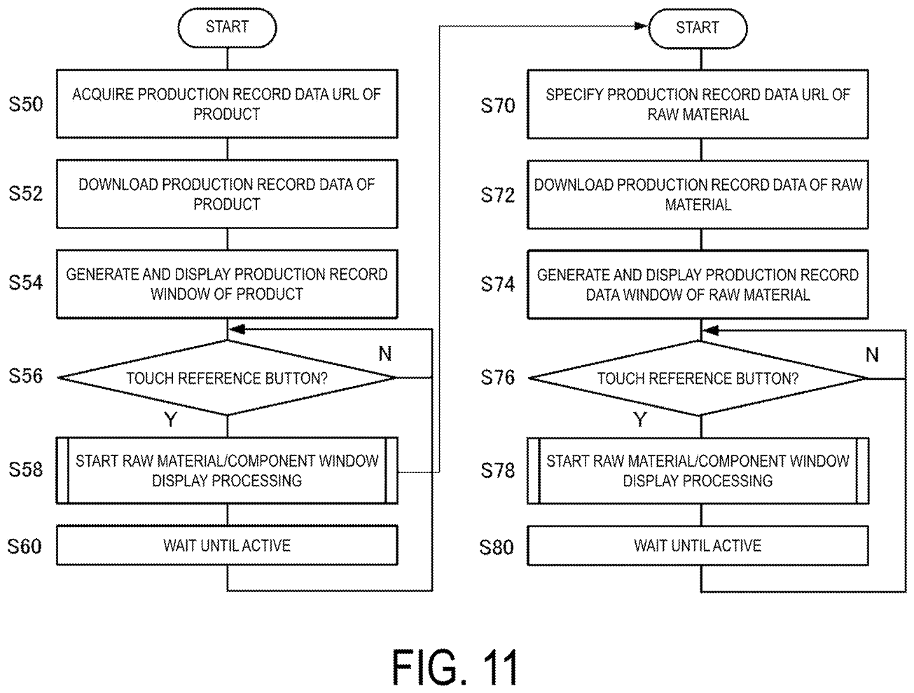

FIG. 11 is a flowchart illustrating a process of trace information display in the user terminal 500.

The URL acquisition unit 582 causes the camera 546 to photograph the graphic code (e.g., a bar code or QR code (registered trade name)) added or attached to the product or causes the RFID reader 544 to read the RF tag added or attached to the product, thereby acquiring the production record data URL of the product (S50).

The network communication unit 540 accesses the acquired production record data URL and downloads the production record data of the product (S52). Downloading means receiving data from a computer (e.g., a web server) on a network. The received data may be stored in a nonvolatile storage area (e.g., a hard disk device), or may be stored only in a volatile storage area (e.g., random access memory) without being stored in the nonvolatile storage area. The production record data output unit 532 generates a production record data window of the product based on the downloaded production record data and displays the generated window on the display (S54). The production record data output unit 532 may display a part of the production record data of the product or may display all of the production record data of the product. The production record data output unit 532 may output a part or all of the production record data of the product in a mode (e.g., printing, transmission, or the like) other than display.

When the accepting unit 520 accepts the touch of the reference button (Y in S56), the window control unit 584 starts the raw material/component window display processing (S58). In this example, assuming use of multi-task processing, the raw material/component window display processing operates in parallel as a task different from the task of the main processing illustrated on the left side of FIG. 11. Then, the window control unit 584 waits until the production record data screen of the product becomes active (S60). When the opened raw material or component production record data window is closed, the production record data screen of the product becomes active, and the processing returns to the processing of S56.

The raw material/component window display processing starts from S70. The network communication unit 540 refers to the record of the raw material or the component in the production record data of the product, and specifies the production record data URL corresponding to the raw material or the component indicated by the touched reference button (S70).

The network communication unit 540 accesses the specified production record data URL and downloads the production record data of the raw material or the component. (S72). The production record data output unit 532 generates a production record data window of the raw material or the component based on the downloaded production record data and displays the generated window on the display (S74). The production record data output unit 532 may display a part of the production record data of the raw material or the component, or may display all of the production record data of the raw material or the component. The production record data output unit 532 may output a part or all of the production record data of the raw material or the component in a mode (e.g., printing, transmission, or the like) other than display.

When the accepting unit 520 accepts the touch of the reference button (Y in S76), the window control unit 584 starts the raw material/component window display processing (S78). Then, the window control unit 584 waits until the opened production record data screen becomes active (S80). When production record data window displayed on top is closed, the original production record data screen becomes active, and the processing returns to the processing of S76.

In this way, the production record data windows of the raw materials or the components are displayed so as to overlap each other by sequentially displaying the production record data windows in an upstream direction. The activation of raw material/component window display processing is repeated for the number of production record data windows to be displayed.

As described above, in the user terminal 500, the production record data of the raw material or the component associated with the product can be obtained, and the production record data of the raw material or the component being upstream can be traced. In addition, only the production record data required by the user can be downloaded by the touch operation of the reference button, and the occurrence of unnecessary traffic can be suppressed.

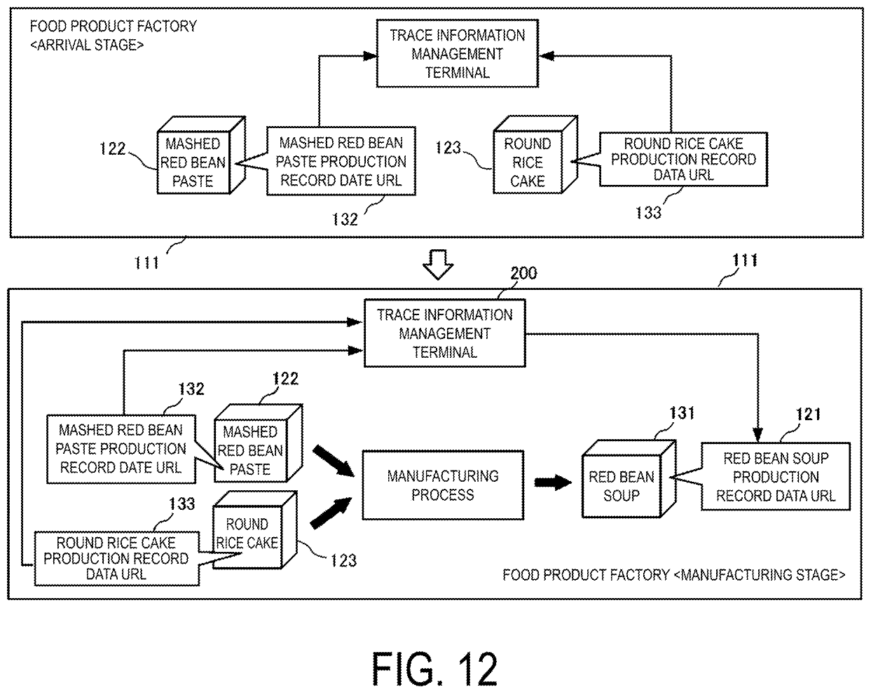

FIG. 12 is a diagram illustrating an outline of the work in the food product factory 111 and an operation of the trace information management system.

The top diagram illustrates a stage where the mashed red bean paste 122 and the round rice cake 123, which are the raw materials of the red bean soup production record data URL 131, have arrived. When the mashed red bean paste 122 arrives, the mashed red bean paste production record data URL 132 is read from the mashed red bean paste 122 and input to the trace information management terminal 200. The trace information management terminal 200 registers the date of the day as the arrival date of the mashed red bean paste 122 in the arrival management data together with the mashed red bean paste production record data URL 132. The arrival management data is data for managing the arrival status of raw materials or components. When the round rice cake 123 arrives, the round rice cake production record data URL 133 is read from the round rice cake 123 and input to the trace information management terminal 200. The trace information management terminal 200 registers the date of the day as the arrival date of the round rice cake 123 in the arrival management data together with the round rice cake production record data URL 133. The arrived mashed red bean paste 122 and the round rice cake 123 are treated as inventory. In this way, by registering the arrival date of the raw material or the component, the input of the arrival date is automated when the production record data is generated.

The bottom diagram illustrates a stage where the red bean soup 121 is manufactured. The manufacturing date of the red bean soup production record data URL 131 does not always coincide with the arrival date of the raw material or the component. The mashed red bean paste 122 and the round rice cake 123 to be used for manufacturing are taken out from the stock. The mashed red bean paste production record data URL 132 is read from the mashed red bean paste 122 to be used and input to the trace information management terminal 200. In addition, the round rice cake production record data URL 133 is read from the round rice cake 123 to be used and input to the trace information management terminal 200. The mashed red bean paste production record data URL 132 and the round rice cake production record data URL 133 are set to the production record data of the red bean soup 121. In addition, the mashed red bean paste production record data URL 132 and the round rice cake production record data URL 133 serve as search keys for searching for the arrival management data.

In the manufacturing process, the mashed red bean paste 122 and the round rice cake 123 are used to manufacture the red bean soup 121. The trace information management terminal 200 generates a production record data of the red bean soup 121 and uploads it to the WEB server 400a. Furthermore, the trace information management terminal 200 records the storage position of the WEB server 400a, that is, the red bean soup production record data URL 131 in the graphic data or the RF tag. In the case of the bean paste manufacturing factory 112, the sugar manufacturing factory 115, and the rice cake manufacturing factory 113, the work and the operation of the trace information management system are performed in a similar procedure.

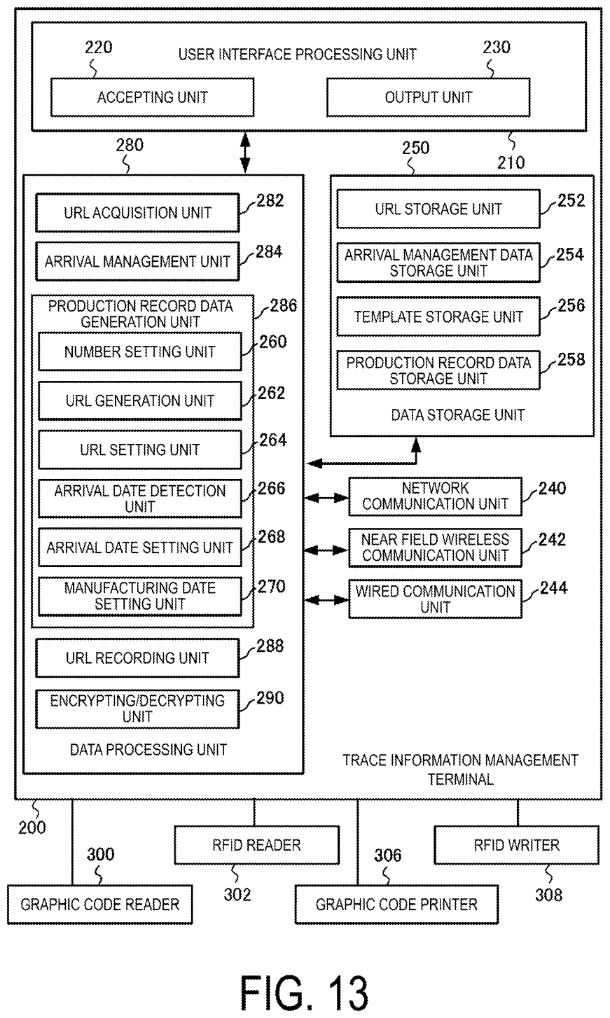

FIG. 13 is a functional block diagram of the trace information management terminal 200.

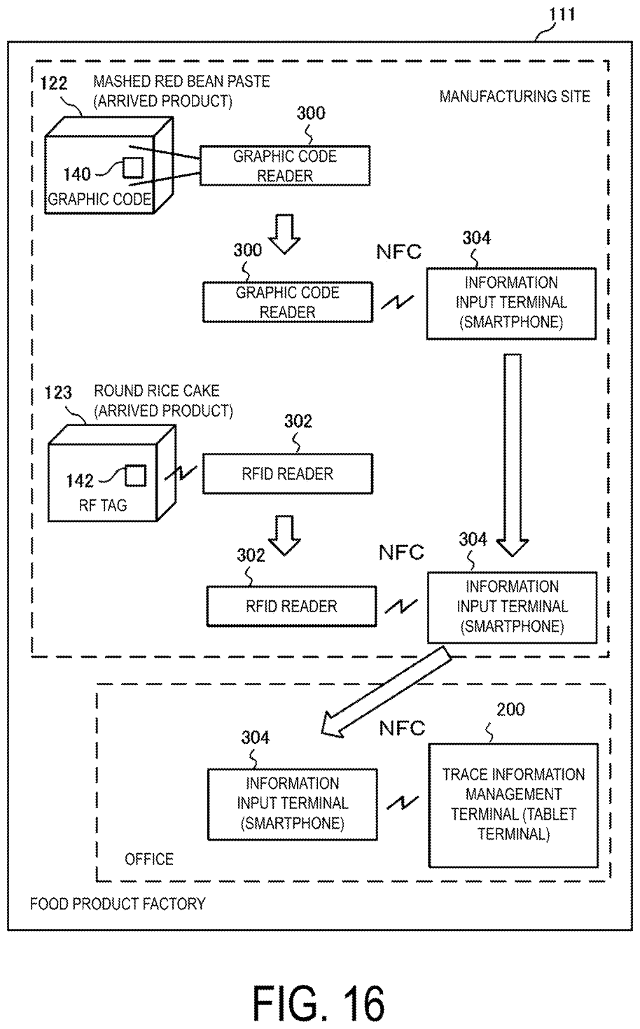

The trace information management terminal 200 includes a user interface processing unit 210, a data processing unit 280, a network communication unit 240, a near field wireless communication unit 242, a wired communication unit 244, and a data storage unit 250. The user interface processing unit 210 accepts an operation from a user via a mouse, a touch panel, or the like, and is also responsible for user interface processing such as image display and audio output. The network communication unit 240 is responsible for communication processing via a network. The near field wireless communication unit 242 is responsible for communication processing by near field wireless communication. The wired communication unit 244 is responsible for wired communication processing. The data storage unit 250 stores various data. The data processing unit 280 executes various kinds of processing based on the data acquired by the network communication unit 240, the near field wireless communication unit 242 and the wired communication unit 244, and the data stored in the data storage unit 250. The data processing unit 280 also functions as an interface of the user interface processing unit 210, the network communication unit 240, the near field wireless communication unit 242, the wired communication unit 244, and the data storage unit 250. The trace information management terminal 200 can communicate with the graphic code reader 300, the RFID reader 302, the graphic code printer 306, and the RFID writer 308 by near field wireless or wired communication. Furthermore, the trace information management terminal 200 can communicate with the information input terminal 304 by near field wireless or wired communication as described with reference to FIG. 16. As described above, the trace information management system can include the trace information management terminal 200, the graphic code reader 300, the RFID reader 302, the information input terminal 304, the graphic code printer 306, and the RFID writer 308.

The user interface processing unit 210 includes an accepting unit 220 to which data is input by a user operation and an output unit 230 that outputs data to be provided to the user.

The data processing unit 280 includes an URL acquisition unit 282, an arrival management unit 284, a production record data generation unit 286, an URL recording unit 288, and an encrypting/decrypting unit 290. The URL acquisition unit 282 acquires the production record data URL of the raw material or the component. The arrival management unit 284 manages an arrival status of the raw material or the component. The production record data generation unit 286 generates production record data of a product. The URL recording unit 288 records the production record data URL of the product on the recording medium. The encrypting/decrypting unit 290 encrypts various data and decrypts the encrypted various data.

The production record data generation unit 286 includes a number setting unit 260, a URL generation unit 262, a URL setting unit 264, an arrival date detection unit 266, an arrival date setting unit 268, and a manufacturing date setting unit 270.

The number setting unit 260 sets an individual/lot number in the production record data of the product. The URL generation unit 262 generates the production record data URL of the product. The URL setting unit 264 sets the production record data URL of the raw material or the component in the production record data of the product. The arrival date detection unit 266 detects the arrival date of the raw material or the component from the arrival management data. The arrival date setting unit 268 sets the arrival date of the raw material or the component in the production record data of the product. The manufacturing date setting unit 270 sets the manufacturing date of the product in the production record data of the product.

The data storage unit 250 includes a URL storage unit 252, an arrival management data storage unit 254, a template storage unit 256, and a production record data storage unit 258.

The URL storage unit 252 stores the production record data URL. The arrival management data storage unit 254 stores the arrival management data. The template storage unit 256 stores a template of the production record data of a product. The template is information serving as a base of the production record data of a product. The production record data storage unit 258 stores production record data.

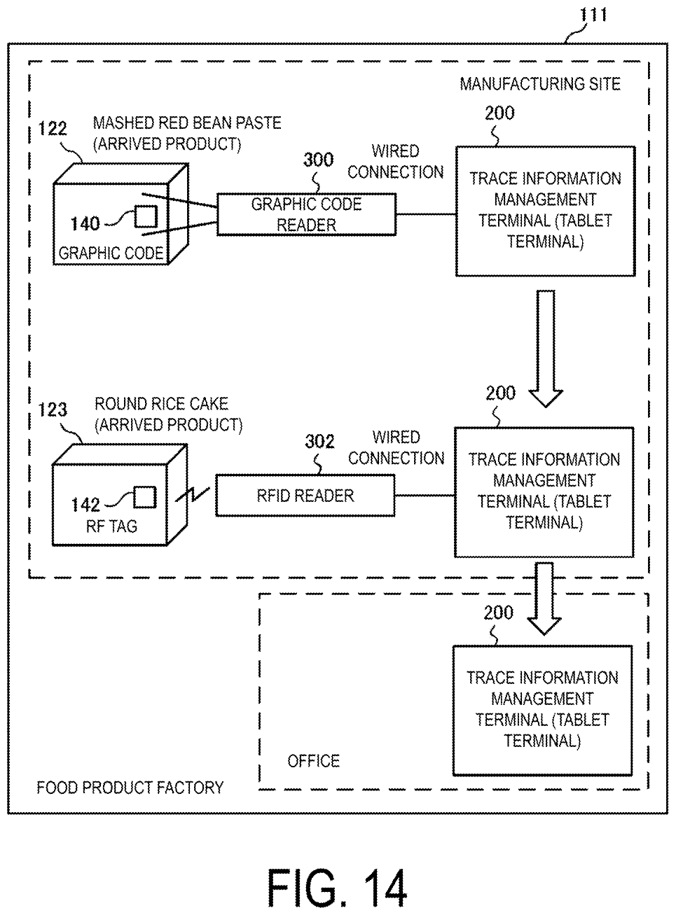

FIG. 14 is a diagram illustrating a first example of the method of collecting the production record data URL.

In this example, a graphic code 140 is added or attached to the mashed red bean paste 122. For example, a graphic code reader 300 is wire connected to the trace information management terminal 200 such as a tablet terminal. When the graphic code reader 300 is brought close to the graphic code 140 of the mashed red bean paste 122, the mashed red bean paste production record data URL 132 is read and input to the trace information management terminal 200.

In addition, an RF tag 142 is added or attached to the round rice cake 123. The RFID reader 302 is wire connected to the trace information management terminal 200. When the RFID reader 302 is brought close to the RF tag 142 of the mashed red bean paste 122, the mashed red bean paste production record data URL 132 is read and input to the trace information management terminal 200. In this manner, the production record data URL of the raw material or the component used at the manufacturing site is read and input to the trace information management terminal 200. Thereafter, for example, production record data of a product is generated by the trace information management terminal 200 in an office.

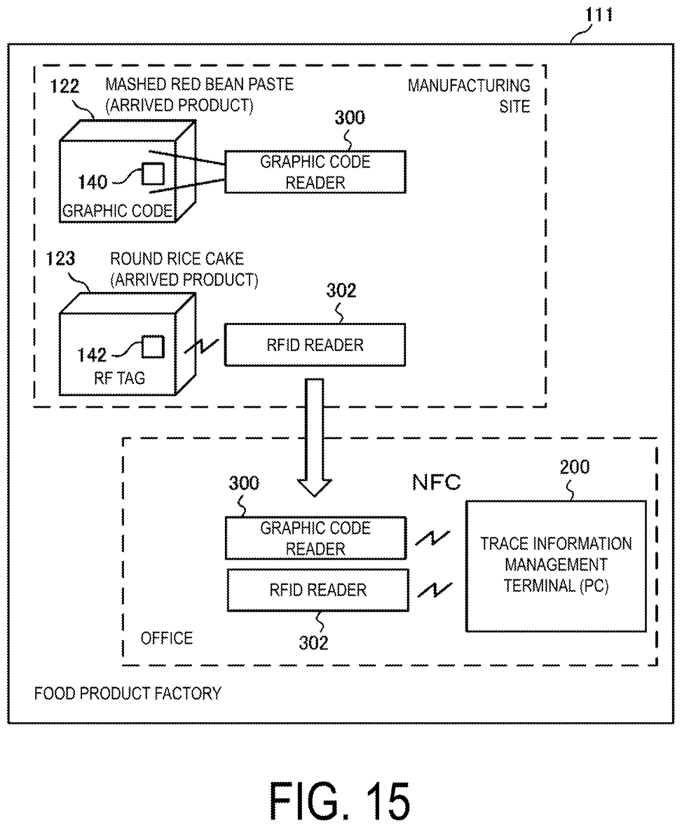

FIG. 15 is a diagram illustrating a second example of the method of collecting the production record data URL.

In this example, the graphic code reader 300 alone reads and holds the mashed red bean paste production record data URL 132. In addition, the RFID reader 302 alone reads and holds the round rice cake production record data URL 133.

Thereafter, the graphic code reader 300 and the RFID reader 302 are moved to, for example, an office and brought close to the trace information management terminal 200 such as a personal computer. The mashed red bean paste production record data URL 132 held in the graphic code reader 300 is transmitted to the trace information management terminal 200 by wireless LAN communication or near field wireless communication such as Bluetooth or near field communication (NFC). Similarly, the round rice cake production record data URL 133 held in the RFID reader 302 is also transmitted to the trace information management terminal 200 by near field wireless communication. Then, the trace information management terminal 200 generates the production record data of the product.

FIG. 16 is a diagram illustrating a third example of the method of collecting the production record data URL.

As in the case of the second example, the graphic code reader 300 alone reads and holds the mashed red bean paste production record data URL 132. In addition, the RFID reader 302 alone reads and holds the round rice cake production record data URL 133.

Then, the mashed red bean paste production record data URL 132 held in the graphic code reader 300 is transmitted to the information input terminal 304 such as a smartphone by near field wireless communication. In addition, the round rice cake production record data URL 133 held in the RFID reader 302 is also transmitted to the information input terminal 304 by the near field wireless communication.

Thereafter, the information input terminal 304 is moved to, for example, an office, and the mashed red bean paste production record data URL 132 and the round rice cake production record data URL 133 held in the information input terminal 304 are transmitted from the information input terminal 304 to the trace information management terminal 200 by the near field wireless communication.

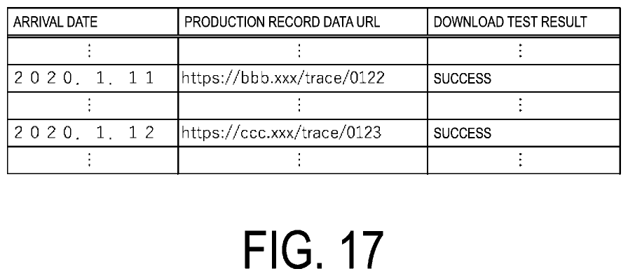

FIG. 17 is a diagram illustrating an example of the arrival management data.

The arrival management data is, for example, in a table format. The arrival management data is provided with a record for each arrived good. In addition, the arrival management data has columns of an arrival date, a production record data URL, and a download test result. The arrival date is the date on which the goods are arrived and registered in the arrival management data. In the arrival management data, a production record data URL is used to specify an arrived good. The download test result indicates a test result as to whether or not the production record data from the production record data URL can be downloaded. If the download test is successful, the arrived good will be stocked as conforming good and used for manufacturing at some point. When the download test fails, that is, when the production record data is not correctly stored in the production record data URL, traceability cannot be ensured, and thus the arrived good will be separately managed as a non-conforming good and will not be used for manufacturing. In the download test, processing of actually accessing the production record data URL and downloading the production record data is executed. In a case where the download processing is successful without causing an error and the entire production record data can be received, the result of the download test is successful. In a case where an error occurs and the download processing fails, and a part or all of the production record data cannot be received, the result of the download test fails. For example, when the production record data is not stored in the production record data URL, the result of the download test fails.

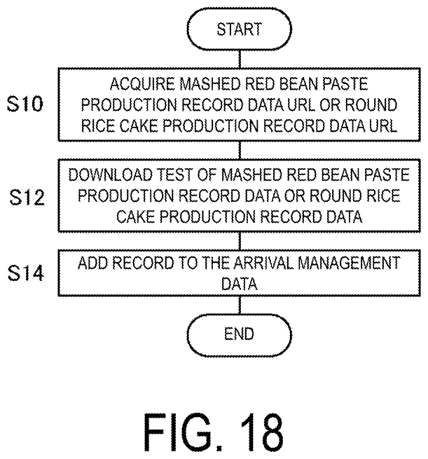

FIG. 18 is a flowchart illustrating a process of performing an arrival processing of a raw material or a component in the trace information management terminal 200.

The URL acquisition unit 282 acquires the mashed red bean paste production record data URL 132 or the round rice cake production record data URL 133 by, for example, the collection method described with reference to FIGS. 14 to 16 (S10).

In a case where the mashed red bean paste production record data URL 132 is acquired, the network communication unit 240 accesses the mashed red bean paste production record data URL 132 and performs a test as to whether or not the mashed red bean paste production record data can be downloaded. Furthermore, when acquiring the round rice cake production record data URL 133, the network communication unit 240 accesses the round rice cake production record data URL 133 and performs a test as to whether or not the round rice cake production record data can be downloaded (S12). The arrival management unit 284 adds a record to the arrival management data and registers the arrival date, the production record data URL, and the download test result (S14).

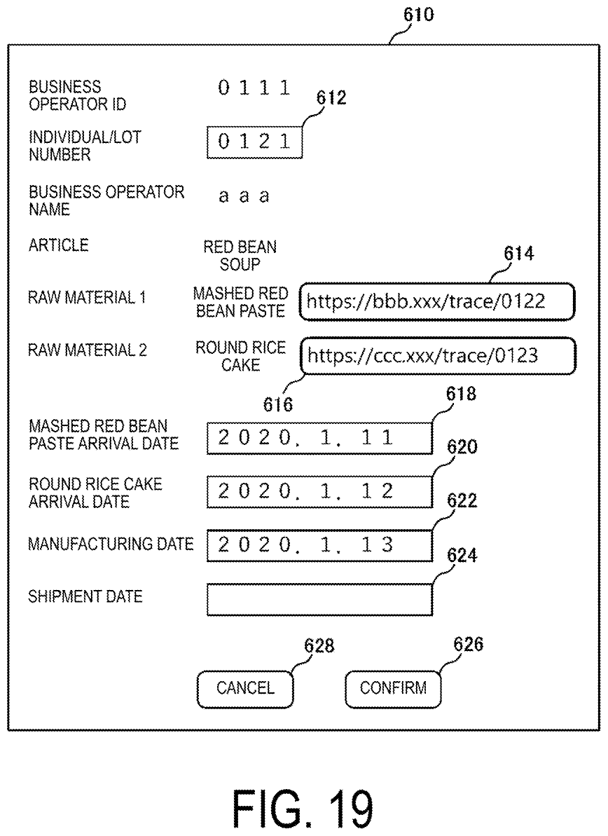

FIG. 19 is a diagram illustrating an example of a production record data editing screen 610 of the red bean soup 121.

The production record data editing screen 610 of the red bean soup 121 is displayed on the display of the trace information management terminal 200 when generating the production record data of the red bean soup 121.

In the item for the business operator ID, a predetermined business operator ID allocated to the food product factory 111 is displayed, and the change is not accepted. For example, consecutive numbers are automatically assigned to the item for the individual/lot number. However, the operator can make a change by re-inputting. In the item for the business operator name, the business operator name “aaa” of the food product factory 111 is displayed, and no change is accepted.

“Red bean soup” is displayed in the item for the article name, “mashed red bean paste” is displayed as the item for the raw material 1, and “round rice cake” is displayed as the item for the raw material 2. No change is accepted for the data values of these items. Raw material 1 URL button 614 is displayed in correspondence with the raw material 1, and raw material 2 URL button 616 is displayed in correspondence with the raw material 2. When the raw material 1 URL button 614 is touched, the mashed red bean paste production record data downloaded from the mashed red bean paste production record data URL 132 of the used mashed red bean paste 122 is displayed. In addition, when the raw material 2 URL button 616 is touched, the round rice cake production record data downloaded from the round rice cake production record data URL 133 of the used round rice cake 123 is displayed. An operator can check whether there is an error by viewing the production record data of the used raw material or component.

The arrival date of the mashed red bean paste 122 registered in the arrival management data at the arrival stage is automatically set in the mashed red bean paste arrival date input region 618. The arrival date of the round rice cake 123 registered in the arrival management data at the arrival stage is automatically set in the round rice cake arrival date input region 620. The date of the day on which the production record data editing screen 610 is displayed is automatically set for the manufacturing date. The date of the mashed red bean paste arrival date, the round rice cake arrival date, and the manufacturing date can be changed by being re-input by the operator. The shipment date is blank. The operator enters the shipment date. If there is a rule for shipping on the next day of the manufacturing date, the date of the next day of the manufacturing date may be automatically set. When the worker touches the confirm button 626, the production record data of the red bean soup 121 is set to the data value of each item displayed on the production record data editing screen 610. When the worker touches the cancel button 628, the data value of each item displayed on the production record data editing screen 610 is discarded.

When there is a setting rule of a shipment date, it is also possible to automatically set all items and automatically generate the production record data. In this case, editing by the production record data editing screen 610 may not be performed. In addition, in a case where each production record data is generated for a plurality of products, since as long as the same data value other than the individual/lot number is used for the second and subsequent production record data, it is possible to automatically generate the second and subsequent production record data by allocating a sequential individual/lot number.

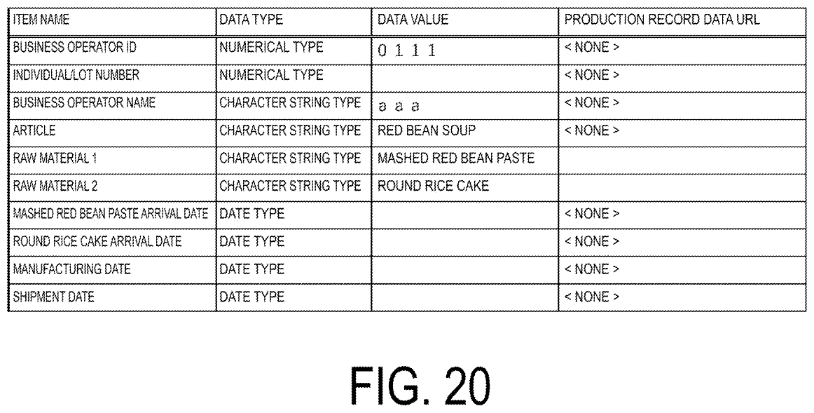

FIG. 20 is a diagram illustrating an example of a template of production record data of the red bean soup 121.

In the template of the production record data of the red bean soup 121, predetermined contents that are not changed are set in advance. The production record data editing screen 610 of the red bean soup 121 described above is displayed based on the item name, the data type, and the data value set in advance in the template of the production record data of the red bean soup 121. In addition, the data value accepted on the production record data editing screen 610 of the red bean soup 121 is set in the blank of the template, thereby completing the production record data of the red bean soup 121.

As described above, for example, consecutive numbers are automatically given to the data values of the individual/lot numbers. In the production record data URL of the raw material 1, the mashed red bean paste production record data URL 132 (e.g., “https://bbb.xxx/trace/0122”) read from the graphic code 140 of the mashed red bean paste container is set. In the production record data URL of the raw material 2, the round rice cake production record data URL 133 (e.g., “https://ccc.xxx/trace/0123”) read from the RF tag 142 of the round rice cake container is set.

The data value of the mashed red bean paste arrival date is set with the arrival date of the mashed red bean paste 122 obtained from the arrival management data. The data value of the round rice cake arrival date is set with the arrival date of the round rice cake 123 obtained from the arrival management data. The data value of the manufacturing date is set with the date of the manufacturing day, and the data value of the shipment date is set with the date accepted on the editing screen described above.

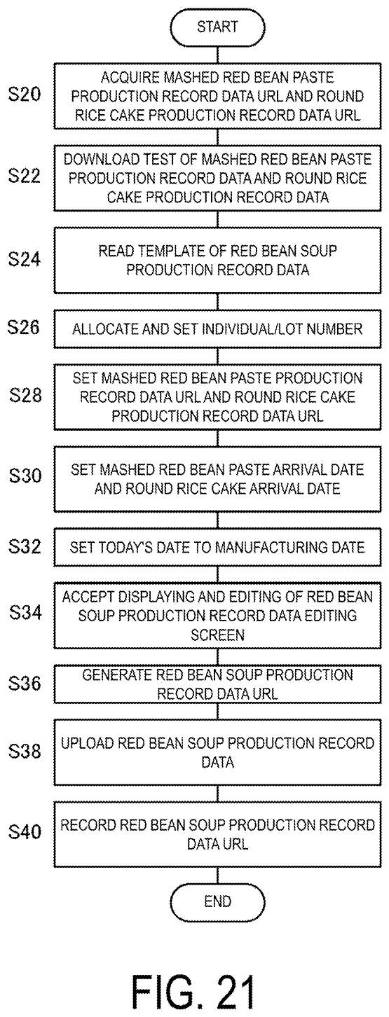

FIG. 21 is a flowchart illustrating a process of issuing production record data in the trace information management terminal 200.

The URL acquisition unit 282 acquires the mashed red bean paste production record data URL 132 and the round rice cake production record data URL 133 by, for example, the method described with reference to FIGS. 14 to 16 (S20).

The network communication unit 240 accesses the acquired mashed red bean paste production record data URL 132 and performs a test as to whether or not the mashed red bean paste production record data can be downloaded. In a case where the mashed red bean paste production record data cannot be downloaded (that is, in a case where the download processing has an error), a warning indicating that the mashed red bean paste production record data cannot be downloaded is output in the output unit 230, and the production record data is not issued. The network communication unit 240 accesses the acquired round rice cake production record data URL 133 and performs a test as to whether or not the round rice cake production record data can be downloaded (S22). In a case where the round rice cake production record data cannot be downloaded (that is, in a case where the download processing has an error), a warning indicating that the mashed red bean paste production record data cannot be downloaded is output in the output unit 230, and the production record data is not issued.

The production record data generation unit 286 reads the template of the red bean soup production record data stored in the template storage unit 256 into the rewritable memory area (S24). Hereinafter, the template of the red bean soup production record data read into the rewritable memory area is updated. The number setting unit 260 assigns, for example, a sequential individual/lot number, and sets the sequential individual/lot number in the field of the data value of the individual/lot number in the template of the red bean soup production record data (S26).

The URL setting unit 264 sets the acquired mashed red bean paste production record data URL 132 in the field of the production record data URL of the raw material 1 in the template of the red bean soup production record data, and sets the acquired round rice cake production record data URL 133 in the field of the production record data URL of the raw material 2 in the template of the red bean soup production record data (S28).

The arrival date detection unit 266 searches the arrival management data using the mashed red bean paste production record data URL 132 as a search key, and detects the mashed red bean paste arrival date. Then, the arrival date setting unit 268 sets the detected mashed red bean paste arrival date in the field of the data value of the mashed red bean paste arrival date in the template of the red bean soup production record data. Furthermore, the arrival date detection unit 266 searches the arrival management data using the round rice cake production record data URL 133 as a search key, and detects the arrival date of 133. Then, the arrival date setting unit 268 sets the detected round rice cake arrival date in the field of the data value of the round rice cake arrival date in the template of the red bean soup production record data (S30).

The manufacturing date setting unit 270 sets today's date in the field of the data value of the manufacturing date in the template of the red bean soup production record data (S32).

The output unit 230 generates a production record data editing screen of the red bean soup 121 based on the template of the red bean soup production record data, and displays the generated screen on the display. The accepting unit 220 accepts editing on the production record data editing screen of the red bean soup 121, that is, an input of a changeable data value (S34). When the accepting unit 220 accepts the touch of the raw material 1 URL button 614, the output unit 230 displays the mashed red bean paste production record data downloaded in S22 on the display. Furthermore, when the accepting unit 220 accepts the touch of the raw material 2 URL button 616, the output unit 230 displays the round rice cake production record data downloaded in S22 on the display.

When the accepting unit 220 accepts the touch of cancel button 628, the processing is interrupted and terminated. When the accepting unit 220 accepts the touch of the confirm button 626, the URL generation unit 262 generates the red bean soup production record data URL (e.g., “https://aaa.xxx/trace/0121”) (S36). Note that “https://aaa.xxx/trace/” is common to the red bean soup 121 produced in the food product factory 111. “0121” is an individual/lot number of the red bean soup 121.

The network communication unit 240 uploads the red bean soup production record data according to the red bean soup production record data URL (S38). That is, the red bean soup production record data generated by updating the template of the red bean soup production record data read into the rewritable memory area is stored in the storage position of the WEB server 400a indicated by the red bean soup production record data URL. The red bean soup production record data URL is uniquely determined by the combination of the business operator and the individual/lot number. When the individual number is used, the respective pieces of red bean soup production record data are stored in different areas for each individual of the red bean soup 121. When the lot number is used, the red bean soup production record data is stored in a common area for each red bean soup 121 produced in the same lot.

The URL recording unit 288 records the red bean soup production record data URL in the recording medium added or attached to the red bean soup 121 (S40). When the recording medium is the graphic code 140, the URL recording unit 288 transmits the red bean soup production record data URL to the graphic code printer 306, and the graphic code printer 306 prints the graphic code 140 obtained by converting the red bean soup production record data URL according to the graphic code format on a sticker or the like used as a recording medium. Alternatively, the graphic code printer 306 may print directly on the product. Then, the sticker is added or attached to the container of the red bean soup 121. When the recording medium is the RF tag 142, the URL recording unit 288 transmits the red bean soup production record data URL to the RFID writer 308, and the RFID writer 308 writes the red bean soup production record data URL into the RF tag 142 according to the RFID method. Then, the RF tag 142 is added or attached to the container of the red bean soup 121. Alternatively, writing may be performed on the RF tag 142 added or attached in advance to the container of the red bean soup 121.

Although the example of the arrival management and the issuance of the production record data in the food product factory 111 has been described above, the arrival management and the issuance of the production record data can be similarly performed in the bean paste manufacturing factory 112, the sugar manufacturing factory 115, and the rice cake manufacturing factory 113. In addition, the production record data can be similarly issued in the red bean farm 114, the glutinous rice farm 116, and the sugar cane farm 117. That is, the food product factory 111, the bean paste manufacturing factory 112, the sugar manufacturing factory 115, the rice cake manufacturing factory 113, the red bean farm 114, the glutinous rice farm 116, and the sugar cane farm 117 each introduce and operate the above-described trace information management system, so that the production record data can be traced with respect to the red bean soup 121 not only to the mashed red bean paste 122, the round rice cake 123, and the sugar 125, which are the intermediate products, but also to the red beans 124, the sugar cane 127, and the glutinous rice 126 which are the original raw materials. As described above, since the issuance of the production record data can be automated, it is possible to realize tracing of production record data in a wide range and in various ways for various products.

In the trace information management system, it is possible to easily generate production record data of a product that enables tracing of production record data of a raw material or a component.

In the trace information management system, after the production record data of the product is uploaded, the production record data URL of the product is recorded on the recording medium, so that the storage state of the production record data of the product can be easily guaranteed. Therefore, traceability becomes more reliable.

In addition, since the trace information management system records the production record data URL of the product in the recording medium after confirming that the production record data of the raw material or the component can be downloaded, it is possible to easily guarantee the storage state of the production record data of the raw material or the component. Therefore, traceability becomes more reliable.

In addition, since the trace information management system registers the production record data URL of the raw material or the component and the arrival date of the raw material or the component in the arrival management data in association with each other after confirming that the production record data of the raw material or the component can be downloaded, it is possible to eliminate the raw material or component that cannot be traced. Therefore, traceability becomes more reliable.

### Modified Example

The network is not limited to the Internet. The network may be an intranet in a LAN environment, or the like. An intra-company server may be used instead of the WEB server.

Data transmitted via the network may be encrypted. For example, the data transmitted in the trace information management terminal 200 may be encrypted by the encrypting/decrypting unit 290. The encrypted data received by the trace information management terminal 200 may be decrypted by the encrypting/decrypting unit 290. The trace information management terminal 200 may decrypt all or a part of the data stored in the data storage unit 250 and then store the data in the encrypting/decrypting unit 290. In addition, the encrypting/decrypting unit 290 may perform data processing after decrypting the encrypted data extracted from the data storage unit 250.

A data storage system in the device (e.g., a WEB server or an intra-company server) that stores the production record data and the trace information management terminal 200 is also not limited. Data may be stored by a method other than a general database method.

The field of products to which the trace information management system can be applied is not limited. It is applicable to general industrial products. In representative examples, the present invention is applicable to mechanical products, electrical products, home electric appliances, electronic devices, recording media, chemical products, petroleum products, paper products, and the like. The present invention is also applicable to food products such as meat products, fish products, confectionery products, noodles, seasonings, beverages, and alcoholic beverages. Furthermore, the present invention is also applicable to textile products, clothing products, leather products, wood products, ornament products, tobacco products, and the like.

In the embodiment, a case has been described in which the production record data of the raw material or the component can be traced by taking the process of manufacturing the product from the raw material or the component to delivering the product to the consumer as an example.

The technology described in the embodiment can be applied to various scenes other than this case.

For example, the present invention can be applied to a car lease/a battery lease or the like that changes a user of a car or a battery. More specifically, by replacing each of the plurality of factories in FIG. 1 with the user and replacing the production record data with the usage status data, the current user of the vehicle body or the battery can appropriately browse the usage condition of the user who used the vehicle body or the battery in the past as the trace information.

For example, when an electric vehicle is a final product, an automobile manufacturer that provides an electric vehicle uses a secondary battery as a component to produce an electric vehicle that is a product. A battery manufacturer providing a secondary battery uses a positive electrode material and a negative electrode material as raw materials, and further uses a separator as a component to produce a secondary battery that is a product. In addition, a positive electrode material manufacturer produces a positive electrode material, a negative electrode material manufacturer produces a negative electrode material, and a separator manufacturer produces a separator. The secondary battery can also be regarded as a final product.

An automobile manufacturer records an Internet protocol (IP) address and a folder path of a server in which electric vehicle production record data is stored in a recording medium added or attached to an electric vehicle, and uploads the electric vehicle production record data to a WEB server of the automobile manufacturer. The battery manufacturer records the IP address of the server in which the secondary battery production record data is stored and the folder path in the recording medium added or attached to the secondary battery, and uploads the secondary battery production record data to the WEB server of the battery manufacturer. The positive electrode material manufacturer records the IP address of the server in which the positive electrode material production record data is stored and the folder path in the recording medium added or attached to the container of the positive electrode material, and uploads the positive electrode material production record data to the WEB server of the positive electrode material manufacturer. The negative electrode material manufacturer records the IP address of the server in which the negative electrode material production record data is stored and the folder path in the recording medium added or attached to the container of the negative electrode material, and uploads the negative electrode material production record data to the WEB server of the negative electrode material manufacturer. The separator manufacturer records the IP address of the server in which the negative electrode material production record data is stored and the folder path in the recording medium added or attached to the container of the separator, and uploads the separator production record data to the WEB server of the separator manufacturer.

The technique described in the embodiment with reference to application examples of the red bean soup 121, the mashed red bean paste 122, the round rice cake 123, the red beans 124, the sugar 125, the sugar cane 127, and the glutinous rice 123 can be applied to an electric vehicle, a secondary battery, a positive electrode material, a negative electrode material, and a separator. In this way, the consumer who has purchased the electric vehicle performs an operation of reading the IP address in which the electric vehicle production record data is stored and the folder path from the recording medium added or attached to the electric vehicle using the user terminal 500, and can browse the electric vehicle production record data, the secondary battery production record data, the positive electrode material production record data, the negative electrode material production record data, and the separator production record data on the trace information screen. In addition, when the electric vehicle is resold, the owner of the new electric vehicle can also view these production record data in the same manner.

The secondary battery may be removed from the electric vehicle and diverted to other devices (e.g., a storage device). Traceability is also ensured for secondary batteries distributed as secondhand products. That is, a person involved in the secondhand market or an owner of the diversion device can perform the operation of reading the secondary battery production record data URL from the recording medium added or attached to the secondary battery using the user terminal 500, and browse the secondary battery production record data, the positive electrode material production record data, the negative electrode material production record data, and the separator production record data on the trace information screen.

The item recorded in the production record data is not limited to the above example. In general, it is conceivable that information related to the quality of a product, a raw material, or a component is recorded, but it is also possible to record other information.

Note that the present invention is not limited to the above-described embodiments and modified examples, and can be realized by modifying the constituent elements without departing from the gist of the present invention. Various inventions may be formed by appropriately combining a plurality of constituent elements disclosed in the above-described embodiments and modified examples. In addition, some constituent elements may be deleted from the constituent elements illustrated in the above embodiments and modified examples.

What is claimed is:

1. An information processing device comprising one or more memories storing instructions and one or more processors that execute the instructions to:
acquire, from a recording medium added to a product, a first address indicating a first storage location on a network related to production record data of the product;
access the first address to receive the production record data of the product;
obtain, from the received production record data of the product, a second address indicating a second storage location on the network related to production record data of a raw material or a component;
access the second address to receive the production record data of the raw material or the component; and
output a part or all of the production record data of the product and the production record data of the raw material or the component.

2. The information processing device according to claim 1, wherein the one or more processors execute the instructions to:
accept a user operation of selecting one raw material or component from among a plurality of raw materials or components; and
access the second address of the one selected raw material or component to receive the production record data, when the user operation is accepted.

3. An information processing system comprising one or more memories storing instructions and one or more processors that execute the instructions to:
acquire, from a first recording medium added to a raw material or a component of a product, a first address indicating a first storage location on a network related to production record data of the raw material or the component;
generate production record data of the product, the production record data including an item for the product and an item for the raw material or the component and associating the acquired first address with the item for the raw material or the component; and
record, on a second recording medium to be added to the product, a second address indicating a second storage location on the network related to the production record data of the product.

4. The information processing system according to claim 3, wherein the one or more processors execute the instructions to:
transmit the production record data of the product to the second storage location; and
record the second address on the second recording medium after transmitting the production record data of the product to the second storage location.

5. The information processing system according to claim 3, wherein the one or more processors execute the instructions to:
access the first address to receive the production record data of the raw material or the component; and
record the second address on the second recording medium after confirming that the production record data of the raw material or the component is receivable.

6. An information processing system comprising one or more memories storing instructions and one or more processors that execute the instructions to:
acquire, from a first recording medium added to a raw material or a component, a first address in an arrival stage of the raw material or the component, the first address indicating a first storage location on a network for storing production record data of the raw material or the component;
register, in arrival management data, the acquired first address and an arrival date of the raw material or the component in association with each other;
generate production record data of a product in a production stage of the product using one or more of the raw materials or the components; detect the arrival date of the one or more of the raw materials or the components by searching the arrival management data based on the first address corresponding to the one or more of the raw materials or the components;
set the arrival date of the one or more of the raw materials or the components in the production record data of the product; and
record, on a second recording medium to be added to the product, a second address indicating a second storage location on the network related to the production record data of the product.

7. The information processing system according to claim 6, wherein the one or more processors execute the instructions to:
access the first address to receive the production record data of the raw material or the component; and
register, in the arrival management data, the acquired first address and the arrival date of the raw material or the component in association with each other after confirming that the production record data of the raw material or the component is receivable.

8. A non-transitory computer-readable medium storing a program executable by an information processing device to perform a method comprising:
acquiring, from a recording medium added to a product, a first address indicating a first storage location on a network related to production record data of the product;
accessing the first address and receiving the production record data of the product;
obtaining, from the received production record data of the product, a second address indicating a second storage location on the network related to production record data of a raw material or a component;
accessing the second address and receiving the production record data of the raw material or the component; and
outputting a part or all of the production record data of the product and the production record data of the raw material or the component.

9. A non-transitory computer-readable medium storing a program executable by an information processing system to perform a method comprising:
acquiring, from a first recording medium added to a raw material or a component of a product, a first address indicating a first storage location on a network related to production record data of the raw material or the component;
generating production record data of the product, the production record data including an item for the product and an item for the raw material or the component and associating the acquired first address with the item for the raw material or the component; and
recording, on a second recording medium to be added to the product, a second address indicating a second storage location on the network related to the production record data of the product.

10. A non-transitory computer-readable medium storing a program executable by an information processing system to perform a method comprising:
acquiring, from a first recording medium added to a raw material or a component in an arrival stage of the raw material or the component, a first address indicating a first storage location on a network for storing production record data of the raw material or the component;
registering, in arrival management data, the acquired first address and an arrival date of the raw material or the component in association with each other;
generating production record data of a product in a production stage of the product using one or more of the raw materials or the components; detecting the arrival date of the one or more of the raw materials or the components by searching the arrival management data based on the first address corresponding to the one or more of the raw materials or the components;
setting the arrival date of the one or more of the raw materials or the components in the production record data of the product; and
recording, on a second recording medium to be added to the product, a second address indicating a second storage location on the network related to the production record data of the product.
